(19) United States
(12) Patent Application Publication
(10) Pub. No.: US 2011/0216180 A1
(43) Pub. Date: Sep. 8, 2011

(54) METHOD AND SYSTEM FOR OBTAINING IMPROVED COMPUTED TOMOGRAPHIC RECONSTRUCTIONS

(76) Inventor: Alessandro PASINI, Cesena (FC) (IT)

(21) Appl. No.: 12/718,292

(22) Filed: Mar. 5, 2010

(51) Int. Cl. H04N 7/18; G06K 9/00

(52) U.S. Cl. 348/77; 382/103; 348/E07.085

(57) ABSTRACT

Methods and systems for obtaining improved computed tomographic reconstructions are provided. A camera obtains one or more images of a patient while a tomographic scan is performed. A CT scanner obtains one or more tomographic projections. The total number of the one or more tomographic projections obtained during the CT scan is determined. For each of the one or more patient images obtained, a processor correlates the patient image with the one or more tomographic projections, calculates a position of the patient and determines if the calculated position of the patient is greater than one or more predetermined constants. If it is determined that the calculated position of the patient is greater than one or more predetermined constants and a total number of the one or more tomographic projections obtained is less than a predetermined number, separate projections are substituted in the place of the one or more tomographic projections that were correlated to the patient image. If it is determined that the calculated position of the patient is greater than one or more predetermined constants and a total number of the one or more tomographic projections is greater than a predetermined number, the tomographic scan is aborted or the tomographic reconstruction is reconstructed on a reduced arc.

### BACKGROUND

1. Field of the Invention

The present disclosure relates generally to computed tomography, and more particularly, to a method and system for obtaining improved computed tomographic reconstructions by using motion tracking correction.

2. Background of the Invention

Computed tomography (“CT”) is a diagnostic procedure that utilizes special x-ray equipment to obtain cross-sectional tomographic radiographic reconstructions of different parts of a patient's body, including, but not limited to, a patient's teeth, organs, bones and tissues. A conventional CT scanner is a special type of x-ray machine where a patient is placed in a machine which has an x-ray source that rotates and produces two or three dimensional reconstructions of the internal structures of the body in a cross-section by measuring the signal strength of x-ray beams which are detected after they pass through a patient's body. One or more detectors transmit the signals to a signal processor which, through an appropriate computer algorithm, creates a snapshot or frame of the body part, representing a cross-sectional “slice” of the area being scanned. Each snapshot or frame is analyzed by a computer, and the full set of snapshots or frames from each rotation is compiled to form two-dimensional or three-dimensional reconstruction scans. The scans can be displayed on a monitor or stored electronically.

A typical CT body scan is performed by having the patient lie flat on a platform, typically, on his/her back or side or stomach. A CT head scan may be performed by having the patient standing, sit upright or lying on his/her back, depending on the model of the tomograph. The acquisition times are slightly longer in this case (a volume is acquired instead of a series of slices). The patient must remain very still to get the best quality images. If the patient moves, the quality of the CT scan is compromised. Straps and pillows may be used to help the patient remain still and maintain their position. However, depending on the length of the procedure, staying in one position may be uncomfortable for a patient. Moreover, physically constraining different body parts during CT scanning may not eliminate possible movement of such parts. In addition, considering that the x-ray dose to the patient for performing a CT scan is quite high (in the order of 30-60 microsievert to 500-1500 microsievert), the repetition of the CT examination should be avoided as much as possible.

Accordingly, there is a need for an improved procedure that minimizes discomfort to patients, precludes any movement by the patient during a CT scan from having an adverse effect on the final two or three dimensional CT image scans and minimizes the amount of x-ray exposure to the patient.

### SUMMARY OF THE INVENTION

To that end, the present invention contemplates improved methods and systems for obtaining computed tomographic reconstructions. A method for obtaining improved computed tomographic reconstructions includes obtaining one or more patient images using a camera, wherein the one or more patient images are obtained while a tomographic scan is performed on the patient; obtaining one or more tomographic projections during the tomographic scan for the patient; determining a total number of the one or more tomographic projections obtained during the tomographic scan; and for each of the one or more patient images obtained, correlating each patient image with the one or more tomographic projections obtained during the tomographic scan, calculating a position of the patient, determining if the calculated position of the patient is greater than one or more predetermined constants, and if it is determined that the calculated position of the patient is greater than one or more predetermined constants and a total number of the one or more tomographic projections obtained during the tomographic scan is less than a predetermined number, substituting a separate projection in place of the one or more tomographic projections that were correlated to the patient image obtained.

Alternatively, a method for obtaining improved computed tomographic reconstructions, includes obtaining one or more patient images using a camera, wherein the one or more patient images are obtained while a tomographic scan is performed on the patient; obtaining one or more tomographic projections during the tomographic scan for the patient; determining a total number of the one or more tomographic projections obtained during the tomographic scan; and for each of the one or more patient images obtained, correlating each patient image with the one or more tomographic projections obtained during the tomographic scan, calculating a position of the patient, determining if the calculated position of the patient is greater than one or more predetermined constants, and if it is determined that the calculated position of the patient is greater than one or more predetermined constants and a total number of the one or more tomographic projections obtained during the tomographic scan is greater than a predetermined number, either the tomographic scan is aborted or the tomographic reconstruction is reconstructed on a reduced arc (for example, 180° instead of 360°).

A method for obtaining improved computed tomographic reconstructions, includes, obtaining one or more patient images using a camera, wherein the one or more patient images are obtained while a computed tomographic scan is performed on a patient; obtaining one or more tomographic projections during the tomographic scan for the patient; determining a total number of the one or more tomographic projections obtained during the tomographic scan; and for each of the one or more patient images obtained, correlating each patient image with the one or more tomographic projections obtained during the tomographic scan; calculating a position of the patient; determining if the calculated position of the patient is greater than one or more predetermined constants; if it is determined that the calculated position of the patient is greater than one or more predetermined constants and a total number of the one or more tomographic projections is less than a predetermined number, substituting a separate projection in place of the one or more tomographic projections that were correlated to the patient image obtained; and if it is determined that the calculated position of the patient is greater than one or more predetermined constants and a total number of the one or more tomographic projections is greater than a predetermined number, aborting the tomographic scan or reconstructing the tomographic reconstruction on a reduced arc.

In addition, the present invention also contemplates a computed tomography system that includes a CT scanner, comprising a support structure, an x-ray source, one or more x-ray detectors positioned opposite the x-ray source and a camera. The camera obtains one or more patient images while a tomographic scan is performed on the patient and is used to determine movement by the patient during the tomographic scan. A processor determines a total number of the one or more tomographic projections obtained during the tomographic scan, and for each of the one or more patient images obtained, correlates each patient image with the one or more tomographic projections obtained during the tomographic scan for the patient. The processor calculates a position of the patient for each of the one or more patient images obtained and determines if the calculated position of the patient is greater than one or more predetermined constants. If it is determined that the calculated position of the patient is greater than one or more predetermined constants and a total number of the one or more tomographic projections obtained during the tomographic scan is less than a predetermined number, the processor substitutes a separate projection in place of the one or more tomographic projections that were correlated to the patient image obtained.

Alternatively, or in addition, a computed tomography system includes a CT scanner, comprising a support structure, an x-ray source, one or more x-ray detectors positioned opposite the x-ray source and a camera. The camera obtains one or more patient images while a tomographic scan is performed on the patient and is used to determine movement by the patient during the tomographic scan. A processor determines a total number of the one or more tomographic projections obtained during the tomographic scan, and for each of the one or more patient images obtained, correlates each patient image with the one or more tomographic projections obtained during the tomographic scan for the patient. The processor calculates a position of the patient for each of the one or more patient images obtained and, determines if the calculated position of the patient is greater than one or more predetermined constants. If it is determined that the calculated position of the patient is greater than one or more predetermined constants and a total number of the one or more tomographic projections obtained during the tomographic scan is greater than a predetermined number, either the tomographic scan is aborted or the tomographic reconstruction is reconstructed on a reduced arc (for example, 180° instead of 360°).

### BRIEF DESCRIPTION OF THE DRAWINGS

The features of the present application can be more readily understood from the following detailed description with reference to the accompanying drawings wherein:

FIG. 1 is a graph representing a typical relationship between the relative movement of a patient or the body part under scrutiny and the number of frames in a CT scan, according to one embodiment of the present disclosure;

FIG. 2 is an improved CT system, according to one embodiment of the present invention;

FIG. 3 is a flow chart illustrating a method for obtaining improved computed tomographic reconstructions, according to one embodiment of the present invention;

FIG. 4 is a flow chart illustrating a method for obtaining improved computed tomographic reconstructions, according to one embodiment of the present invention; and

FIG. 5 is a flow chart illustrating a method for obtaining improved computed tomographic reconstructions, according to one embodiment of the present invention.

### DETAILED DESCRIPTION OF THE PREFERRED EMBODIMENTS

The present invention provides a method and system for obtaining improved computed tomographic reconstructions by using motion tracking correction.

To obtain accurate CT images, a patient must remain very still during a CT scan. The slightest movement of the patient or the body part under scrutiny may compromise the quality of the CT images. The object of the present invention is to provide a method and system to detect movement of a patient or body part during a CT scan and correct that movement when necessary to preserve the image resolution of the CT images and the resulting quantitative tomography data.

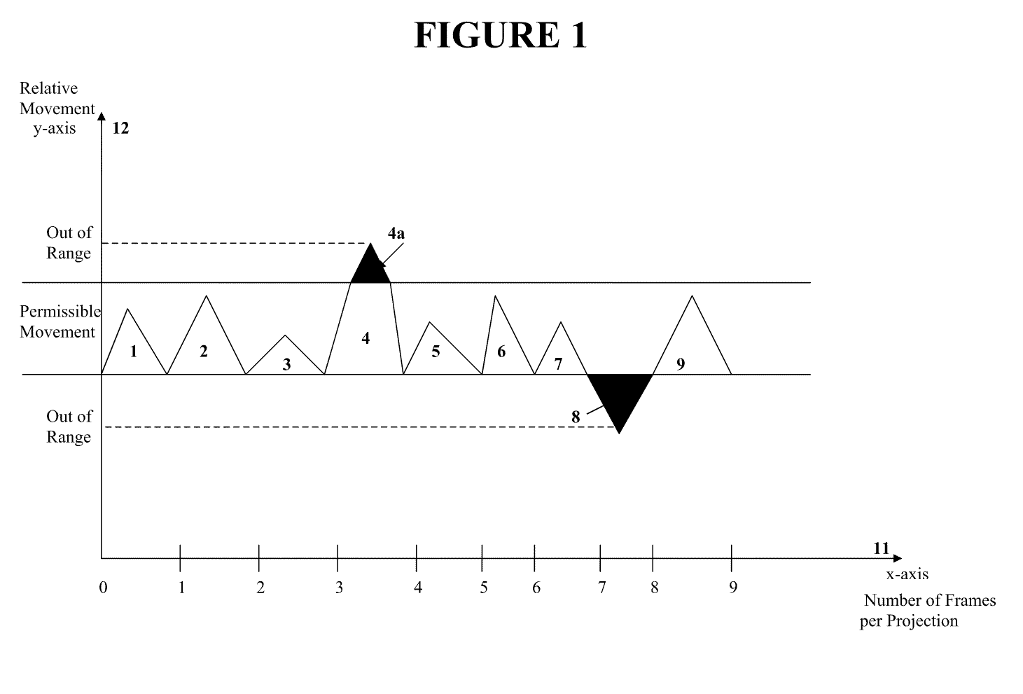

FIG. 1 is a graph representing a typical relationship between the relative movement of a patient or the body part under scrutiny and the number of frames in a CT scan, according to one embodiment of the present disclosure. The x-axis (11) depicts nine frames which are obtained during the CT scan. The y-axis (12) depicts the range of relative movement. Frames 1-3, 5-7 and 9 appear to be permissible as they fall within the range of acceptable movement. However, part of frame 4, namely 4a, and frame 8 fall outside the range of acceptable movement. Prior art CT systems do not provide ways to correct frames 4a and 8, often making another CT scan necessary.

The system and method of the present disclosure provide for the detection of frames 4a and 8 as outside the range of permissible movement and allow for the correction of that movement by the substitution of either a black projection, blank projection, artificial projection, one or more obtained tomographic projections, or a reconstructed frame from the previous or succeeding frames falling within the range of acceptable movement, namely, frames 1-3, 5-7 and 9. According to an embodiment, if the detection of frames 4a and 8 is outside the range of permissible movement and there are not enough tomographic radiographs or projections, the examination may be aborted or the tomographic reconstruction is reconstructed on a reduced arc (for example, 180° instead of 360°).

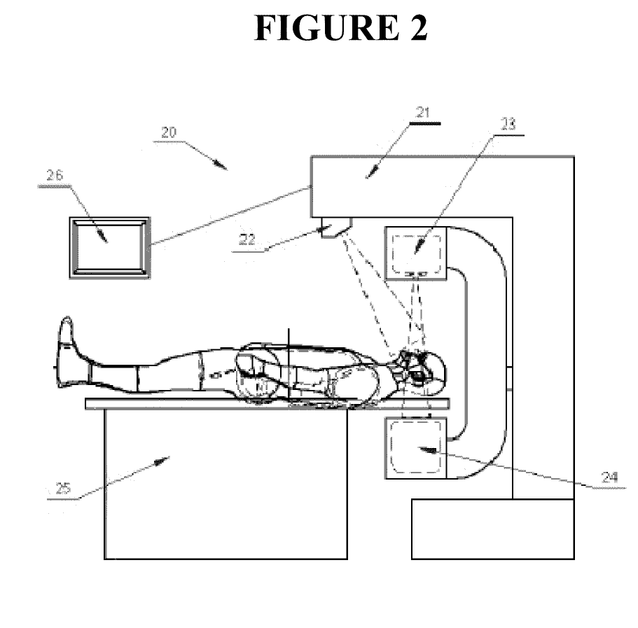

FIG. 2 is an improved CT system, according to one embodiment of the present invention. The improved CT system can be implemented for both a patient that is laying down on a platform, as illustrated in FIG. 2, or a standing or sitting patient, which is not illustrated. The patient may be either a human or an animal patient. The CT system comprises a CT scanner 20 which includes a support structure 21, an x-ray source 23, one or more x-ray detectors 24 positioned opposite to the x-ray source, a platform 25 to support the patient, and a camera 22, such as, for example, a fixed or moveable digital camera, digital video camera, or digital video recorder or any other mechanism that is able to acquire visible images (as opposed to radiographic), and a processing unit 26. In a preferred embodiment, the position of the camera is fixed, and the camera must remain in the same position throughout the whole acquisition of projections. In another embodiment, the camera may rotate during the acquisition of projections. The processing unit 26 either is a separate unit from the CT scanner, which may communicate with the CT scanner through a network or the like connected by wired or wireless means, such as, for example, the Internet, LAN, infrared data communication, radio wave communication, satellite communication, or any other means that is well known to one of ordinary skill in the art, or an integral part of the CT scanner 20. The x-ray source 23 may produce a pencil beam, fan beam or cone beam. The platform 25 may also be a chair for an upright patient. The one or more x-ray detectors 24 may be analog or digital.

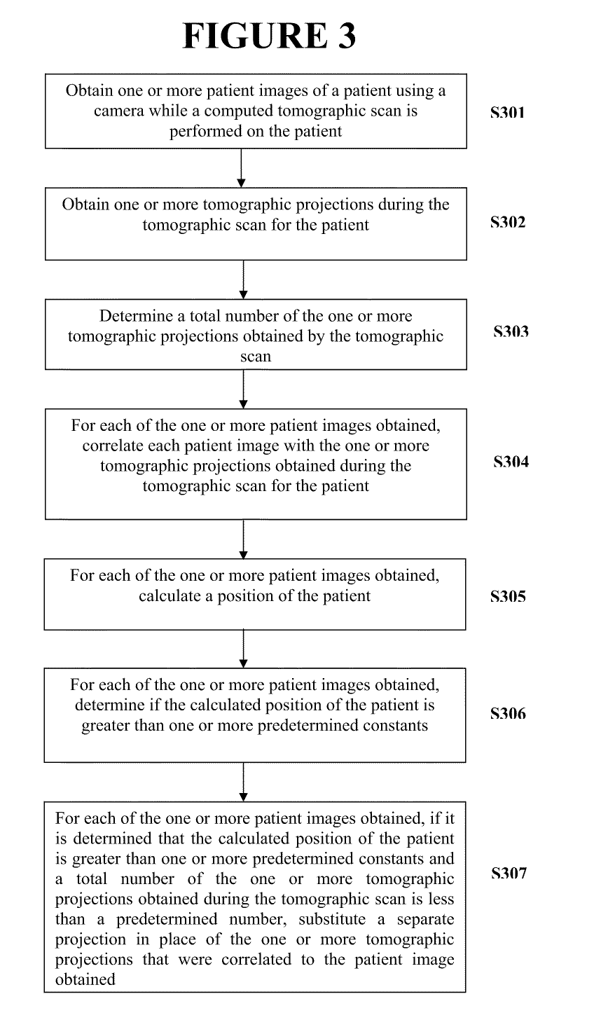

FIG. 3 is a flow chart illustrating a method for obtaining improved computed tomographic reconstructions, according to one embodiment of the present invention. The camera 22 obtains one or more patient images of a patient while a tomographic scan is performed on the patient (Step S301). The CT scanner 20 obtains one or more tomographic projections during the CT scan for the patient (Step S302). A processing unit 26 determines a total number of the one or more tomographic projections obtained during the CT scan (Step S303). The number of projections obtained during the CT scan affects the reconstruction quality by impacting the contrast, noise and resolution of the projections. The more tomographic projections that are obtained during the tomography scan, the better the image quality.

For each of the one or more patient images obtained, the processing unit 26 also correlates each patient image with the one or more tomographic projections obtained during the CT scan (Step S304). In other words, the one or more patient images are synchronized with the CT scan x-ray projections.

The processing unit 26 also calculates a position of the patient for each of the one or more patient images obtained (Step S305) and determines if the calculated position of the patient is greater than one or more predetermined constants (Step S306).

The calculated position of the patient could be keyed into a body part, such as a patient's nose, and is used to determine whether or not the patient moved during the CT scan. The position of the patient for each of the one or more patient images obtained may be calculated by using methodologies that are known to one of ordinary skill in the art, such as, for example, segmentation of face region based on color, detection of local facial landmarks, and/or motion movement determination.

For example, one variation is to use CIECAM for measuring color appearance which does not vary with illuminating conditions. A second variation is to use Behavior Model of Vision (BMV) which simulates some mechanisms of the human vision system for perceiving shapes. A third variation is to use a simplified retina-like neural network model for motion detection. These models are used for color segmentation of the facial area on initial pictures, detection of Local Facial Landmarks (“LFL”) (external eye corners and middle point of nose basement), and motion movement determination, respectively.

The one or more predetermined constants are the maximum amount of distance that is allowed for each calculated position. For example, the position for a first obtained patient image may be determined and then used as a constant to determine the positions of each subsequently obtained patient image. The one or more predetermined constants may be the same value for all of the one or more patient images. The value of the one or more predetermined constants may be related to the image resolution, such as, for example, the pixel size each of the one or more obtained patient images.

For each of the one or more patient images obtained, if it is determined that the calculated position of the patient is greater than one or more predetermined constants and a total number of the one or more tomographic projections obtained during the CT scan is less than a predetermined number, the processing unit 26 substitutes a separate projection in place of the one or more tomographic projections that were correlated to the patient image (Step S307). The separate projection also may be a blank projection, a black projection, an artificial projection or a copy of an obtained tomographic projection. The number of projections that can be substituted is determined experimentally, so that the quality of the CT reconstruction remains acceptable.

If the separate projection is reconstructed, there may be an alert that is generated to inform the user that the quality of the image may be inferior than expected.

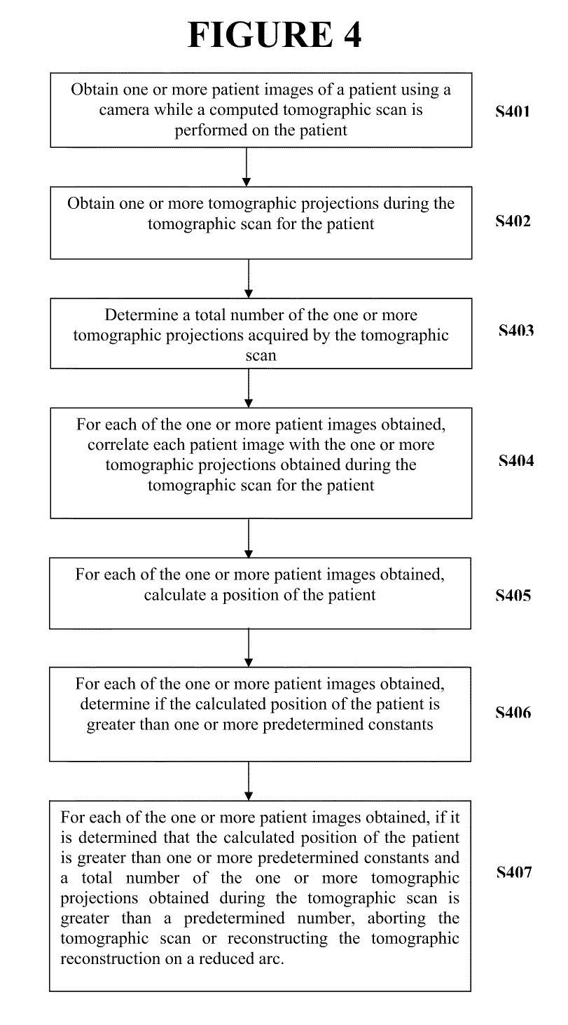

FIG. 4 is a flow chart illustrating a method for obtaining improved computed tomographic reconstructions, according to one embodiment of the present invention. The camera 22 obtains one or more patient images of a patient while a tomographic scan is performed on the patient (Step S401). The CT scanner 20 obtains one or more tomographic projections during the CT scan for the patient (Step S402). A processing unit 26 determines a total number of the one or more tomographic projections obtained during the CT scan (Step S403). For each of the one or more patient images obtained, the processing unit 26 also correlates each patient image with the one or more tomographic projections obtained during the CT scan (Step S404), calculates a position of the patient (Step S405) and determines if the calculated position of the patient is greater than one or more predetermined constants (Step S406). For each of the one or more patient images obtained, if it is determined that the calculated position of the patient is greater than one or more predetermined constants and a total number of the one or more tomographic projections obtained during the CT scan is greater than a predetermined number, the processing unit 26 either aborts the examination, or, if possible, reconstructs the tomographic reconstruction on a reduced arc (for instance, 180° instead of 360°) (Step S407). According to an embodiment, the tomographic reconstruction may be a reconstructed projection from the one or more obtained tomographic projections using a reduced angular range algorithm. If there is a tomographic reconstruction, there may be an alert generated to inform the viewer that the quality of the reconstruction may be less than the standard. If the reconstruction is aborted because the number of projections is not sufficient, a corresponding alert will be generated for the user.

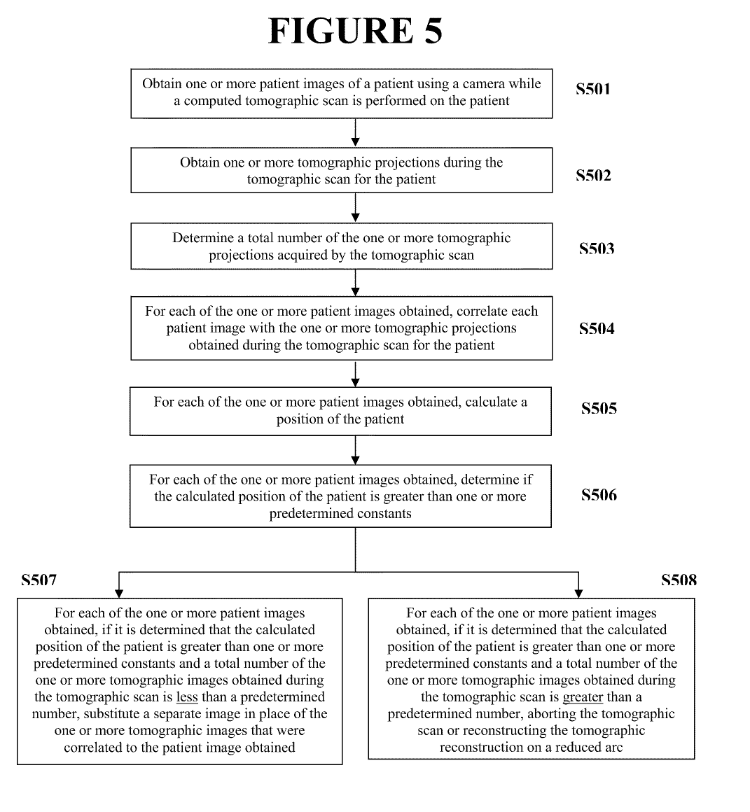

FIG. 5 is a flow chart illustrating a method for obtaining improved computed tomographic reconstructions, according to one embodiment of the present invention. The camera 22 obtains one or more patient images of a patient while a tomographic scan is performed on the patient (Step S501). The CT scanner 20 obtains one or more tomographic projections during the CT scan for the patient (Step S502). A processing unit 26 determines a total number of the one or more tomographic projections obtained during the CT scan (Step S503). For each of the one or more patient images obtained, the processing unit 26 also correlates each patient image with the one or more tomographic projections obtained during the CT scan (Step S504), calculates a position of the patient (Step S505) and determines if the calculated position of the patient is greater than one or more predetermined constants (Step S506). For each of the one or more patient images obtained, if it is determined that the calculated position of the patient is greater than one or more predetermined constants and a total number of the one or more tomographic projections obtained during the CT scan is less than a predetermined number, the processing unit 26 substitutes a separate image in place of the one or more tomographic projections that were correlated to the patient image obtained (Step S507). The separate projection substituted may be a blank projection, a black projection, an artificial projection or a copy of an obtained tomographic projection. For each of the one or more patient images obtained, if it is determined that the calculated position of the patient is greater than one or more predetermined constants and a total number of the one or more tomographic projections obtained during the CT scan is greater than a predetermined number, the processing unit 26, can either abort the tomographic scan or reconstruct the tomographic reconstruction on a reduced arc. (Step S508).

According to an embodiment, the reconstructed image may be reconstructed by using a reduced angular range algorithm. In this instance, there may be an alert generated to inform the viewer that the quality of the image may be less than the standard.

By using the above-described methods and system, more accurate computed tomographic reconstructions may be obtained.

Numerous additional modifications and variations of the present invention are possible in view of the above teachings.

What is claimed is:

1. A method for obtaining improved computed tomographic reconstructions, comprising:
obtaining one or more patient images using a camera, wherein the one or more patient images are obtained while a computed tomographic scan is performed on a patient;
obtaining one or more tomographic projections during the tomographic scan for the patient;
determining a total number of the one or more tomographic projections obtained during the tomographic scan; and
for each of the one or more patient images obtained,
correlating each patient image with the one or more tomographic projections obtained during the tomographic scan;
calculating a position of the patient;
determining if the calculated position of the patient is greater than one or more predetermined constants; and
if it is determined that the calculated position of the patient is greater than one or more predetermined constants and a total number of the one or more tomographic projections is less than a predetermined number, substituting a separate projection in place of the one or more tomographic projections that were correlated to the patient image obtained.

2. The method of claim 1, wherein the camera is a digital camera or digital video recorder.

3. The method of claim 1, wherein a value of each of the one or more predetermined constants is a pixel size of each of the one or more obtained patient images.

4. The method of claim 1, wherein the one or more predetermined constants are the same value.

5. The method of claim 1, wherein the separate projection is a blank projection, a black projection, an artificial projection or a copy of an obtained tomographic projection.

6. A method for obtaining improved computed tomographic reconstructions, comprising:
obtaining one or more patient images using a camera, wherein the one or more patient images are obtained while a computed tomographic scan is performed on a patient;
obtaining one or more tomographic projections during the tomographic scan for the patient;
determining a total number of the one or more tomographic projections obtained during the tomographic scan; and
for each of the one or more patient images obtained,
correlating each patient image with the one or more tomographic projections obtained during the tomographic scan;
calculating a position of the patient;
determining if the calculated position of the patient is greater than one or more predetermined constants; and
if it is determined that the calculated position of the patient is greater than one or more predetermined constants and a total number of the one or more tomographic projections is greater than a predetermined number, aborting the tomographic scan or reconstructing the tomographic reconstruction on a reduced arc.

7. The method of claim 6, wherein the camera is a digital camera or digital video recorder.

8. The method of claim 6, wherein a value of each of the one or more predetermined constants is a pixel size of each of the one or more obtained patient images.

9. The method of claim 6, wherein the one or more predetermined constants are the same value.

10. The method of claim 6, wherein the separate image is a reconstructed image from the one or more obtained tomographic projections.

11. A method for obtaining improved computed tomographic reconstructions, comprising:
obtaining one or more patient images using a camera, wherein the one or more patient images are obtained while a computed tomographic scan is performed on a patient;
obtaining one or more tomographic projections during the tomographic scan for the patient;
determining a total number of the one or more tomographic projections obtained during the tomographic scan; and
for each of the one or more patient images obtained,
correlating each patient image with the one or more tomographic projections obtained during the tomographic scan;
calculating a position of the patient;
determining if the calculated position of the patient is greater than one or more predetermined constants;
if it is determined that the calculated position of the patient is greater than one or more predetermined constants and a total number of the one or more tomographic projections is less than a predetermined number, substituting a separate projection in place of the one or more tomographic projections that were correlated to the patient image obtained; and
if it is determined that the calculated position of the patient is greater than one or more predetermined constants and a total number of the one or more tomographic projections is greater than a predetermined number, aborting the tomographic scan or reconstructing the tomographic reconstruction on a reduced arc.

12. A computed tomography system, comprising:
a CT scanner, comprising a support structure, an x-ray source, one or more x-ray detectors positioned opposite the x-ray source and a support for a patient;
a camera for obtaining one or more patient images while a tomographic scan is performed on the patient and for determining movement by the patient during the tomographic scan; and
a processor for
determining a total number of the one or more tomographic projections obtained during the tomographic scan; and
for each of the one or more patient images obtained,
correlating each patient image with the one or more tomographic projections obtained during the tomographic scan for the patient;
calculating a position of the patient;
determining if the calculated position of the patient is greater than one or more predetermined constants;
if it is determined that the calculated position of the patient is greater than one or more predetermined constants and a total number of the one or more tomographic projections is less than a predetermined number, substituting a separate projection in place of the one or more tomographic projections that were correlated to the patient image obtained; and
if it is determined that the calculated position of the patient is greater than one or more predetermined constants and a total number of the one or more tomographic projections is greater than a predetermined number, aborting the tomographic scan or reconstructing the tomographic reconstruction on a reduced arc.

13. The computed tomography system of claim 12, wherein camera is a digital camera or digital video recorder.

14. The computed tomography system of claim 12, wherein a value of each of the one or more predetermined constants is a pixel size of each of the one or more obtained patient images.

15. The computed tomography system of claim 12, wherein the one or more predetermined constants are the same value.

16. The computed tomography system of claim 12, wherein if it is determined that the total number of the one or more tomographic projections obtained during the tomographic scan is less than a predetermined number, the separate projection substituted is a blank projection, a black projection, an artificial projection or a copy of an obtained tomographic projection.

17. The computed tomography system of claim 12, wherein if it is determined that the total number of the one or more tomographic projections obtained during the tomographic scan is greater than a predetermined number, the tomographic reconstruction is a reconstructed image from the one or more obtained tomographic projections.
